(19) United States
(12) Patent Application Publication
(10) Pub. No.: US 2023/0147763 A1
(43) Pub. Date: May 11, 2023

(54) PREASSEMBLED COMPONENT FOR A CONNECTABLE ELEMENT ASSEMBLY FOR THE RECONSTITUTION OF FLUID DRUGS AND NUTRIENTS WITH ACTIVE SUBSTANCE IN POWDER, LIQUID OR GEL FORM

(71) Applicant: Paolo Gobbi Frattini S.R.L., Milano (IT)

(72) Inventor: Paolo Giuseppe GOBBI FRATTINI, Sondalo So (IT)

(73) Assignee: Paolo Gobbi Frattini S.R.L., Milano (IT)

(21) Appl. No.: 17/983,550

(22) Filed: Nov. 9, 2022

(30) Foreign Application Priority Data
Nov. 9, 2021 (IT) 202021000005270

(51) Int. Cl. A61J 1/20

(52) U.S. Cl. CPC A61J 1/2096; A61J 1/2006; A61J 1/2037

(57) ABSTRACT

A preassembled component (1) for connectable element assembly for the reconstitution of fluid drugs and nutrients with active substances in powder, liquid or gel form, consists of a female connector (2) with a hermetic closing valve (8) openable by pressure and automatically hermetically reclosable upon the removal of the pressure, which is directly fastened to a coupling and piercing device (3) for vials or the like.

### BACKGROUND OF THE INVENTION

The present invention relates to a preassembled component for a connectable element assembly usable for the reconstitution of fluid drugs and nutrients with active substances in powder, liquid or gel form.

In hospitals there is often the need to administer dosed amounts of active substances of various type, in particular drugs or nutrients, which are made available separately, in particular in powder, liquid or gel form, inside conveniently sealed vials.

In order to make the active substances suitable for administration (infusion or other method), forming a liquid mixture comprising, in addition to the active substance, a liquid solution acting as a diluent or solvent is required.

It is highly important that the formation of this mixture and the introduction thereof into a bag usable for the administration to the patient occurs under absolutely sterile conditions so as to avoid contamination of the active substance and dangers for the medical and nursing staff, which could arise from the possible toxicity of the active substance, if in the form of a drug.

These safety conditions are particularly relevant and more difficult to obtain if drugs with multiple doses of the same active substance or with doses of different active substances, in both cases taken from as many vials, are reconstituted in the same bag.

Italian patent application No. 102020000027669 filed on Nov. 18, 2020 to the same Applicant describes a connectable element assembly which precisely achieves this result. Such an assembly comprises a flexible bag containing a liquid solution and is provided with a first valve connector with a hermetic sealed valve openable by pressure and automatically hermetically reclosable upon the removal of said pressure, at least one vial containing an active substance in powder, liquid or gel form and provided with a hermetic closing cap openable by pressure, a coupling and piercing device couplable to the closing cap of the vial for piercing said cap, and an adapter interposed between said first connector and said coupling and piercing device. The adapter has a hollow outer body with a first end fixable by screwing to said first connector, an axially perforated coaxial inner stem, which upon said screwing causes the closing valve of the first connector to open, and a second end including a second valve connector with a hermetic closing valve openable by pressure and automatically hermetically reclosable upon the removal of said pressure. The second connector is connectable to said coupling and piercing device by means of a flexible tube and is screwable in said outer body so that said stem causes the closing valve of said second connector to open by axial pressure.

Once assembled, the assembly described allows sequentially opening the hermetic closing valves of the two connectors to allow the liquid solution to pass from the bag to an underlying vial containing an active substance to form a fluid mixture of liquid solution and active substance. By overturning the assembly, it is then possible to transfer the fluid mixture from the vial to the bag, which can then be separated from the rest of the assembly (vial, coupling and piercing device, flexible tube, and adapter) to be used after closing the valves of the two connectors.

### SUMMARY OF THE INVENTION

It is the object of the present invention to provide a pre-assembled component which is usable in the assembly described above in order to eliminate the need for the flexible tube which connects the second connector to the coupling and piercing device of the vial and which can cause detachments or fluid leakages which must absolutely be avoided.

Such an object is achieved by a pre-assembled component comprising a valve connector with a hermetic closing valve openable by pressure and automatically hermetically reclosable upon the removal of said pressure, which is directly fluid-tightly fastened to a coupling and piercing device of a vial or the like, as defined in the claims of this invention.

The preassembled component according to the invention can thus be used to connect directly, without the need for an intermediate flexible tube and thus in the total absence of detachments or fluid leakages, a vial containing an active substance to an adapter in turn connectable to the valve connector of a flexible bag containing an active solution to obtain an assembly of the type described in Italian patent application No. 102020000027669 dated Nov. 18, 2020.

### DESCRIPTION OF THE DRAWINGS

The features of the present invention will become apparent from the following detailed description of an embodiment thereof, shown by way of example in the accompanying drawings, in which:

FIG. 1 shows the outer shape of a component according to the invention in assembled condition;

FIG. 2 shows an axial cross-section view of FIG. 1;

FIG. 3 shows an axial cross-section of the two parts of before the assembly thereof;

FIG. 4 shows an axial section of FIG. 1 after the connection thereof to an adapter connectable to the outlet connector of a flexible bag.

### DETAILED DESCRIPTION OF THE INVENTION

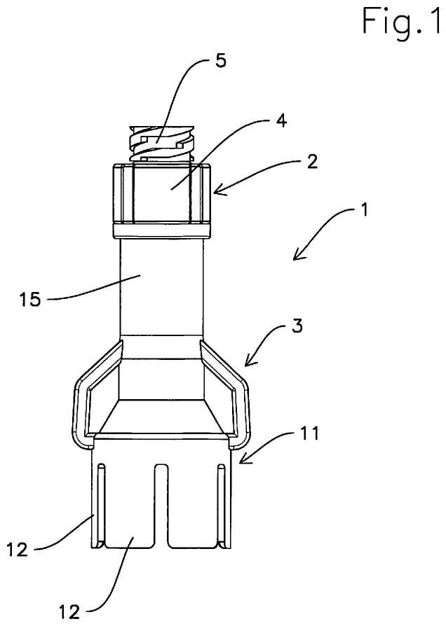

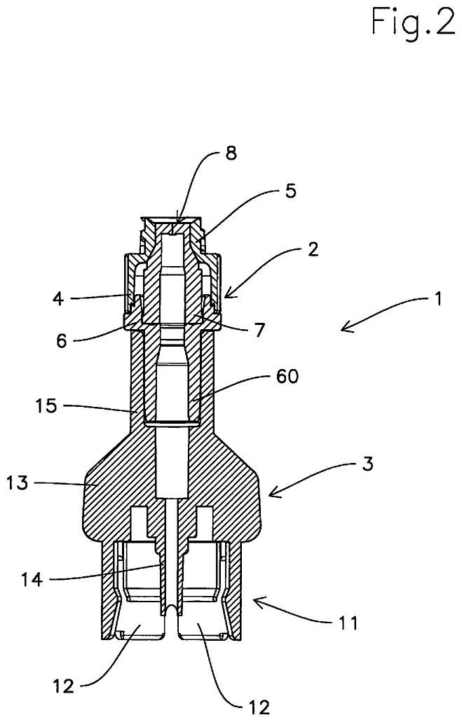

The component shown in FIGS. 1 and 2, indicated as a whole by reference numeral 1, consists of two mutually interlocking parts, which are a female connector 2 and a coupling and piercing device 3 for a vial or the like provided with a pierceable closing cap (not shown).

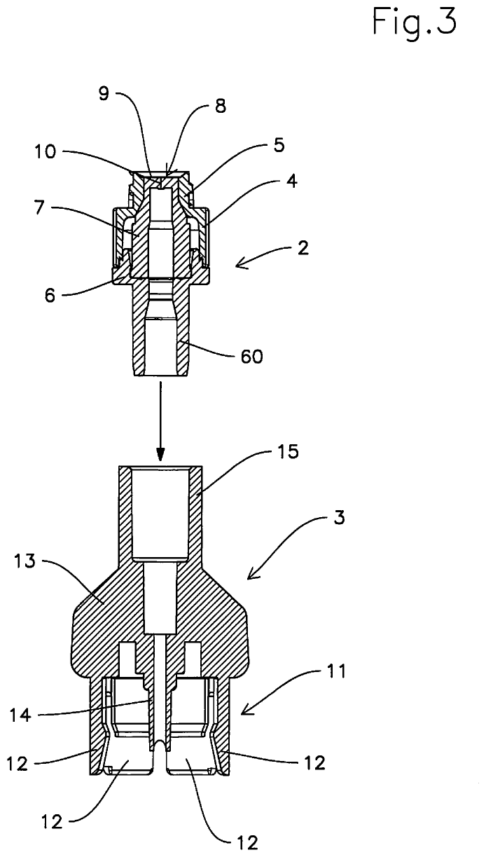

As better seen in FIG. 3, the female connector 2 comprises an outer body 4 having, at a first end of the female connector 2, a tubular projection 5 of small diameter, provided with an outer thread adapted to fasten the female connector 2 inside an internally threaded seat. An inner body 7 is coaxially inserted and retained by a locking element 6 in the outer body 4, the inner body being axially pierced as is the locking element 6, and has a valve element 8 inside the tubular projection 5 of the outer body 4, consisting of a flexible membrane 9 with axial slot 10 normally hermetically closed. The flexible membrane 9, and the valve element 8 therewith, is openable by means of axial pressure exerted from the outside and automatically hermetically reclosable upon the removal of such a pressure. For more details on the operating mode of the aforesaid valve element 8, reference should be made to the content of EP 2 667 839 B1. An axially pierced leg 60 of the locking element 6 finally extends outwards from the other end of the female connector 2 in continuation of the inner body 7.

The coupling and piercing device 3, shown in FIG. 3, has a coupling part consisting of a cuff 11 with toothed sectors 12 circumferentially distributed and spaced from one another, which are intended to be coupled to the cap of a vial or the like. The coupling and piercing device 3 further has a part connecting to the female connector 2, and consists of an axially pierced body 13 which has an axial leg 14 inside the cuff 11, preferably but not necessarily with tip-shaped ends, which is intended to be forcedly inserted by pressure through the cap of a vial, preferably but not necessarily of the type described in EP 2 867 132 B1.

As described in EP 2 867 132 B1, the content of which is referred to herein for further details, when the toothed sectors 12 of the cuff 11 are coupled below the mouth of the vial, the leg 14 pierces the closing cap of the vial to end in the inner space of the vial itself.

Finally, the device 3 includes, at the opposite end with respect to the cuff 11, an axial tubular projection 15 of the connection part 3 in which the axially pierced leg 60 of the female connector 2 is axially insertable by forced pressure. In this way, the female connector 2 and the coupling and piercing device 3 form a single preassembled component 1 forming the object of the present invention and which is shown from the outside and in axial section in FIGS. 1 and 2, respectively.

While the coupling and piercing device 3 is intended to be coupled to the neck of a vial or the like and to pierce the closing cap thereof, the female connector 2 is intended to be inserted, axially pushed and engaged by rotation inside an adapter of the type described in Italian patent application No. 102020000027669 dated Nov. 18, 2020 to ultimately form, together with the vial coupled to the coupling and piercing device 3 and to a valve connector connected to a flexible bag screwable inside the adapter, a connectable element assembly for the reconstitution of drugs or nutrients of the type described in the aforesaid application.

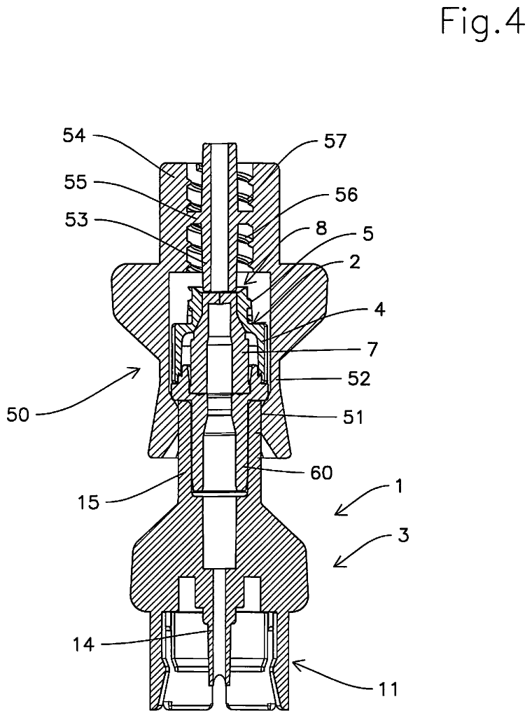

The connection of the pre-assembled component in FIGS. 1 and 2 to an adapter of the aforesaid type is exemplarily shown in axial section in FIG. 4, where it is seen that the female connector 2 of the pre-assembled component 1 has been inserted into an adapter 50 after being axially pushed through a narrow end portion 51 of the inner axial hole of the hollow outer body 52 of the adapter and up to the head contact with a hollow stem 53 which is coaxial to a leg 54 of the outer body 52 and made integral therewith by a crosspiece 55 interposed between two inner threads 56, 57 of the leg 54.

As seen in FIG. 4, the hollow stem 53 axially protrudes at both ends with respect to the leg 54. By further pushing the connector 2 towards the interior of the adapter 50, this allows causing, by axially inserting the inner end of the hollow stem 53, and then maintaining, by screwing the outer thread on the tubular projection of 5 thereof with the inner thread 56 of the adapter, the opening of the valve element 8 of the connector 2.

By virtue of the protruding outer end of the hollow stem 53 and the thread 57 of the leg 54, the adapter 50 can also receive and lock by screwing a male valve connector for flexible bags of the type described in EP 2 667 839 B1 while causing and maintaining the opening of the valve element contained in the male connector.

Thereby it is possible to make the connection between a vial with active substance coupled to the preassembled component 1 and a flexible bag with liquid solution provided with such a male connector to form an assembly as described in Italian patent application No. 102020000027669 and use it as also described in the aforesaid application.

1. A preassembled component for a connectable element assembly for the reconstitution of fluid drugs and nutrients with active substances in powder, liquid or gel form, wherein a female connector with a hermetic closing valve openable by pressure and automatically hermetically reclosable upon the removal of the pressure, is directly fastened to a coupling and piercing device for vials or the like.

2. The preassembled component according to claim 1, wherein one end of the female connector has a tubular projection with an outer thread.

3. The preassembled component according to claim 1, wherein an opposite end of the female connector has an axially pierced leg.

4. A The preassembled component according to claim 3, wherein the coupling and piercing device comprises a coupling part consisting of a cuff with toothed sectors circumferentially distributed and spaced from one another and a connection part consisting of an axially pierced body which has at one end an axial leg extending into the cuff and is insertable by axial pressure through a cap of a vial and has an axial tubular projection at an opposite end in which an axially pierced leg of the female connector is axially insertable by forced pressure.

5. The preassembled component according to claim 4, wherein the axial leg has a tip-shaped end.
